(19) United States
(12) Patent Application Publication
(10) Pub. No.: US 2024/0401886 A1
(43) Pub. Date: Dec. 5, 2024

(54) A METHOD OF ADJUSTING OXOACIDITY

(71) Applicant: HYME ENERGY APS, Copenhagen N. (DK)

(72) Inventors: Luca SILVIOLI, Copenhagen N. (DK); Ask Emil LØVSHALL-JENSEN, Copenhagen N. (DK); Mahla SEYEDI, Copenhagen N. (DK); James AMPHLETT, Copenhagen N. (DK); Daniel John COOPER, Copenhagen N. (DK); Biyash BHATTACHARYA, Copenhagen N. (DK)

(21) Appl. No.: 18/698,000

(22) PCT Filed: Oct. 7, 2022
(86) PCT No.: PCT/EP2022/077931

§ 371 Date: Apr. 2, 2024

(30) Foreign Application Priority Data
Oct. 7, 2021 (EP) 21201498.9

(51) Int. Cl. F28D 20/00; G05D 21/02; G21C 17/022

(52) U.S. Cl. CPC F28D 20/0034; G05D 21/02; F28D 2020/0047; F28D 2020/0078; G21C 17/022

(57) ABSTRACT

The present invention relates to a method of adjusting the oxoacidity of a molten metal hydroxide salt, the method comprising the steps of: estimating a target concentration of at least one of H₂O, O²⁻, and OH— in a molten salt of a metal hydroxide; providing an oxoacidity control component; and contacting the oxoacidity control component with the molten salt of a metal hydroxide to adjust the oxoacidity of the molten salt of a metal hydroxide. The method allows better utilisation of the available temperature range for a molten salt of a metal hydroxide by reducing the corrosive nature of the metal hydroxide.

### FIELD OF THE INVENTION

The present invention relates to a method of adjusting the oxoacidity of a molten metal hydroxide salt. The method allows better utilisation of the available temperature range for a molten salt of a metal hydroxide by reducing the corrosive nature of the metal hydroxide.

### BACKGROUND

Molten salts are generally highly corrosive, but the physical and chemical properties of molten salts make them attractive for specific applications. In particular, molten hydroxide salts are potentially useful as neutron moderators in fission processes and they may be used over a larger range of temperatures than for example molten salts of chlorides, nitrates, carbonates, etc., which is useful in e.g. energy storage.

Despite the corrosive nature of molten metal hydroxide salts, their use as neutron moderators in fission processes has been described. For example, WO 2020/157247 uses single crystal corundum as a corrosion resistant material in contact with a molten hydroxide moderator salt in a molten salt nuclear fission reactor (MSR). However, single crystal corundum is expensive and its use as a construction material for large scale systems is therefore limited.

Molten salts may comprise water and other components, which will contribute to define the property “oxoacidity” of the molten salt. In molten salts containing hydroxides, the hydroxide ion is an amphoteric species, which can accept a proton to become H₂O as well as donate a proton to become the superoxide ion O²⁻. Water present in the molten salt reacts by Equation 1 and Equation 2

$$2 {H}_{2} O ⇄ {H}_{3} {O}^{+} + {OH}^{-} \qquad Equation 1$$

$$2 {OH}^{-} ⇄ {H}_{2} O + {O}^{2 -} \qquad Equation 2$$

In the present context, we define the oxoacidity as pH₂O=−log₁₀[H₂O] and the oxobasicity is pO²⁻=−log₁₀[O²⁻], in analogy with the well-known definition of PH=−log₁₀[H⁺] and pOH=−log₁₀[OH] in aqueous phase chemistry.

The oxoacidity may aid in predicting the stability of certain species in molten salts as it is described by B. L. Trémillon in Chemistry in Non-Aqueous Solvents, Springer Netherlands, Dordrecht, 1974. doi: 10.1007/978-94-010-2123-4 and in Acid-Base Effects in Molten Electrolytes, in: Molten Salt Chemistry, 1987: pp. 279-303. For example, alumina is an exemplary material, which is slightly soluble in acidic and neutral melts, and is very soluble in basic melts. In acidic melts it dissolves as AlO⁺, and in basic melts it dissolves as AlO₂⁻. However, Tremillon notes that the combination of an oxidised species with a base stabilises the system, which explains why easily oxidised species are more stable in basic media. Conversely, oxidised species are generally much less stable in an acidic system where the base is easily combined with the acidic species, and as a result the reduced species is favoured. However, for many metal alloys there is an oxoacidity range where an alloy can exist in stable equilibrium at oxoacidic/oxobasic conditions. Thus, there exists a range of water concentrations in a molten hydroxide where a material is sufficiently stable to be used as a containment material.

WO 2018/229265 also discloses an MSR having a molten metal hydroxide as a moderator salt. The molten moderator salt may comprise a redox-element having a reduction potential larger than that of the material in contact with the molten moderator salt or being a chemical species, e.g. water, which controls the oxoacidity of the molten moderator salt. WO 2018/229265 suggests bubbling water gas through the molten moderator salt or using an inert cover gas comprising the chemical species which control the redox potential and/or the oxoacidity of the melt, and H₂O, H₂ and HF are mentioned as exemplary chemical species. However, WO 2018/229265 does not disclose how the oxoacidity is controlled in practice.

It is an object of the invention to provide a method that allows utilising the large range of temperature between the melting and boiling points of molten hydroxide salts in industrial applications, and it is a further objection to provide a method that allows molten hydroxides to be used in large scale.

### SUMMARY

The present invention relates to a method of adjusting the oxoacidity of a molten metal hydroxide salt in an energy or heat storage container where the hydroxide salt provides a medium for energy or heat storage, the method comprising the steps of: estimating a target concentration of at least one of H₂O, O²⁻, and OH⁻ in a molten salt of a metal hydroxide; providing an oxoacidity control component; and contacting the oxoacidity control component with the molten salt of a metal hydroxide to adjust the oxoacidity of the molten salt of a metal hydroxide. In particular, the oxoacidity may be adjusted with respect to the concentrations of one or more of H₂O, O²⁻, and OH⁻ to match the corresponding target concentrations, e.g. so that the adjustment provides oxoneutral conditions. Adjusting the oxoacidity allows for corrosion mitigation in molten metal hydroxide salts, and therefore the method may also be considered a method of adjusting oxoacidity for corrosion mitigation in molten metal hydroxide salts, or a method of corrosion mitigation in molten metal hydroxide salts. In a specific example of the method, the oxoacidity is adjusted to oxoneutral conditions, e.g. for a specific lining material, in the step of contacting the oxoacidity control component with the molten salt of a metal hydroxide to adjust the oxoacidity of the molten salt of a metal hydroxide. The metal hydroxide may be any metal hydroxide as desired, but the metal hydroxide is preferably a hydroxide of an alkali metal, e.g. sodium, potassium, or lithium hydroxide, or their mixtures, or the metal hydroxide may be a hydroxide of an earth alkaline metal, e.g. calcium or magnesium. Likewise, the metal hydroxide may be hydroxides of different metals.

The method of adjusting the oxoacidity of a molten metal hydroxide salt is especially relevant for an energy or heat storage container where the hydroxide salt provides a medium for energy or heat storage. In another aspect, the invention relates to an energy storage system comprising a container, a heat sink and/or a heat source, and a molten metal hydroxide salt located in the container, wherein the molten salt of a metal hydroxide is circulated in the container by forced convection obtained from the heat sink and/or the heat source, which heat sink and/or which heat source is configured to create a temperature gradient in the range of 0.1° C./cm to 10° C./cm over a distance from the heat sink and/or the heat source, as appropriate, to a point in the molten salt of a metal hydroxide. The heat sink and/or the heat source may for example be configured to contact the molten salt of a metal hydroxide over a distance from the lining material in the range of 0 cm to 100 cm. In a specific embodiment, the distance from the heat sink and/or the heat source, as appropriate, to the point in the molten salt of a metal hydroxide is in the range of 5 cm to 20 cm.

In an example, the method of adjusting the oxoacidity of a molten metal hydroxide salt comprises providing a container having an inner surface made from a material of interest, which container comprises a molten salt of a metal hydroxide, and which container comprises a heat source and/or a heat sink configured to create a temperature gradient in the range of 0.1° C./cm to 10° C./cm in the molten salt of a metal hydroxide; estimating a window of oxoacidity, e.g. a target concentration, for the material of interest of at least one of H₂O, O²⁻, and OH⁻ in a molten salt of a metal hydroxide; providing an oxoacidity control component; and contacting the oxoacidity control component with the molten salt of a metal hydroxide to adjust the oxoacidity of the molten salt of a metal hydroxide.

By adjusting the oxoacidity of the molten salt of a metal hydroxide, the method allows that the oxoacidity is adjusted to have an optimal value for a material in contact with the molten salt of a metal hydroxide to thereby minimise the corrosion of the material otherwise caused by molten hydroxide salt, and the method of the disclosure may thus be used in any context where a molten hydroxide salt is useful or appropriate. For example, the method may be used in a molten salt nuclear fission reactor (MSR) where the hydroxide salt serves as a moderator of a nuclear fission process, in an energy or heat storage container where the hydroxide salt provides a medium for energy or heat storage, or in scrubber units operating with molten hydroxides, e.g. pure molten hydroxides. It is especially preferred to estimate the target concentration of H₂O and/or O²⁻, but even though the molten salt is a molten salt of a metal hydroxide, estimating a target concentration of OH⁻ is nevertheless relevant, as indicated in Equation 1 and Equation 2.

The molten salt of a metal hydroxide may be contacted with the oxoacidity control component using any procedure as desired. For example, the oxoacidity control component may be on a gaseous, liquid, or solid form, which may be contacted directly with molten salt of a metal hydroxide.

The method may employ a processing gas, which comprises an inert carrier gas and an oxoacidity control component. For example, the oxoacidity control component may be provided in a processing gas comprising an inert carrier gas, and the method may further comprise contacting the processing gas comprising the oxoacidity control component with the molten salt of a metal hydroxide to adjust the oxoacidity of the molten salt of a metal hydroxide. In the present context, an inert is any gas that does not react with the molten salt of a metal hydroxide or materials in contact with the molten salt of a metal hydroxide. Exemplary inert gasses are nitrogen (N₂) and noble gasses, e.g. helium, neon, argon, and their mixtures or combinations. By providing the oxoacidity control component in a processing gas, the amount of oxoacidity control component brought into contact with the molten salt of a metal hydroxide can be easily controlled to thereby adjust and maintain the oxoacidity of the molten salt of a metal hydroxide to be in the window of oxoacidity most suitable for protection of the lining material of a container where the molten salt of a metal hydroxide is located.

In the present context, the oxoacidity control component may be any chemical entity, e.g. an element, a molecule or an ion, that can influence the concentration of at least one of OH⁻, O²⁻, and H₂O in a molten salt, especially a molten salt of a metal hydroxide. The influence on the concentration of the at least one of OH⁻, O²⁻, and H₂O may be direct or indirect, and the influence may involve increasing or decreasing the concentration, e.g. according to Equation 1 and Equation 2. In particular, all of OH⁻, O²⁻, and H₂O are considered oxoacidity control components in the context of the present method, and likewise, molecules including OH⁻ or O²⁻ and appropriate counter ions are also considered oxoacidity control components. Water, H₂O, in particular in vapour form, is a preferred oxoacidity control component. Water, H₂O, may also exist as hydrates in salts or crystals, and salts containing water hydrates may also be used as oxoacidity control components. When a salt contains water hydrates, the number of water molecules in the salt is normally denoted “x·H₂O” together with the stoichiometric composition of the salt, and the value of x may be employed to determine the amount of the salt to adjust the oxoacidity. Other oxoacidity control components are metal oxide salts, e.g. oxide salts of the same metal as the metal of the molten salt of a metal hydroxide. Molecules capable of binding with OH⁻, O²⁻, and/or H₂O are also considered oxoacidity control components in the present context.

When a processing gas is employed, the processing gas is brought into contact with the molten salt of a metal hydroxide. Thereby, the oxoacidity control component is also brought into contact with the molten salt of a metal hydroxide, and the oxoacidity of the molten salt of a metal hydroxide can be adjusted. In general, the amount of oxoacidity control component brought into contact with the molten salt of a metal hydroxide is determined by the concentration of the oxoacidity control component in the processing gas, the pressure of the processing gas and the amount of processing gas, e.g. expressed as unit of volume per unit of time, such as m³/min, brought into contact with the molten salt of a metal hydroxide. The amount of oxoacidity control component relevant for a specific example of the method is determined by the estimate(s) of the target concentrations of the at least one of OH⁻, O²⁻ and H₂O in a molten salt of a metal hydroxide and the chemical reaction equilibrium between the chosen oxoacidity control component and one or more of OH⁻, O²⁻, and H₂O present in the molten salt of a metal hydroxide. The oxoacidity control components may also be added to the molten salt of a metal hydroxide without the use of a processing gas. For example, solid metal oxide like lithium or sodium oxide can be added in the form of solid pellets into the molten salt in suitable quantities to achieve the target concentration of any of OH⁻, O²⁻, and H₂O in a molten salt of a metal hydroxide. In another example, molten potassium hydroxide hexahydrate can be titrated into the molten salt of a metal hydroxide, to achieve the target concentration of any one of OH⁻, O²⁻, and H₂O. It is also possible to contact oxides, e.g. Li₂O or Na₂O, with the molten salt of a metal hydroxide with the metal oxides being in a molten form.

The molten salt of a metal hydroxide may be located in any kind of container, piping or tubing when brought into contact with the processing gas. In the present context, a material in contact with the molten salt of a metal hydroxide will be referred to as the “lining material”. Thus, the lining material is exposed to the molten salt of a metal hydroxide. In general, materials will have a “window of oxoacidity” where the resistance to corrosion is optimal, i.e. if the oxoacidity is too high or too low, the material will be corroded too fast by the molten salt of a metal hydroxide for the lining material to be used in a practical setting. The oxoacidity corresponding to the window of oxoacidity may also be referred to as “oxoneutral” conditions. The container has an inner surface made from a lining material. The container may be made from any material, e.g. a metal, a metal alloy, a ceramic material or a combination thereof, and in the present context this material is referred to as the container material. The inner surface may be a surface of the container material so that the lining material is the container material, or the container material may be coated with a further material thus providing the lining material. For example, the container material may be a metal alloy, e.g. a nickel based alloy, a nickel based superalloy or a Hastelloy, or nickel. In the present context, a nickel based alloy is an alloy having at least 50% w/w nickel.

When the molten salt of a metal hydroxide is located in a container, the molten salt of a metal hydroxide may be stationary, or the molten salt of a metal hydroxide may circulate in the container by natural convection, forced convection or forced circulation. In general, forced circulation involves stirring the molten salt of a metal hydroxide. Any kind of stirring may be used in the method. In the present context, natural convection is considered to involve movement in the molten salt of a metal hydroxide occurring due to gradients in temperature and/or concentrations of the components of the molten salt of a metal hydroxide without any active steps being performed to influence the convection. When no active steps are taken to create gradients in temperature and/or concentrations, the molten salt of a metal hydroxide is generally considered stationary in the present context. In contrast, forced convection is considered to involve movement in the molten salt of a metal hydroxide caused by actively introducing gradients in temperature and/or concentrations, especially temperature. For example, localised heating of a volume of the molten salt of a metal hydroxide may cause a localised expansion of the molten salt of a metal hydroxide near the heat source, which causes movements in the molten salt of a metal hydroxide. Likewise, localised cooling of a volume of the molten salt of a metal hydroxide may cause a localised contraction of the molten salt of a metal hydroxide near the heat sink, which causes movements in the molten salt of a metal hydroxide. Forced convection and forced circulation allow that the oxoacidity in the molten salt of a metal hydroxide is generally uniform, e.g. the oxoacidity may vary within 30% of an average oxoacidity over the volume of the molten salt of a metal hydroxide. In the present context, forced circulation may be expressed in terms of volumetric replacement over time and have the unit per hour (or h⁻¹), e.g. the volumetric replacement may be in the range of 0.1 h⁻¹ to 100 h⁻¹, e.g. 1 h⁻¹ to 20 h⁻¹. Thereby, forced circulation and forced convection are advantageous to avoid a situation where localised variations in the molten salt of a metal hydroxide creates regions where the oxoacidity is outside the window of oxoacidity.

The molten salt of a metal hydroxide is preferably located in a container, and there will typically be a cover gas above the molten salt of a metal hydroxide, e.g. the container may have a lid covering the molten salt of a metal hydroxide to provide a closed system, although the lid may also have openings to control the composition and the pressure of the cover gas. The cover gas may be maintained at a pressure above ambient pressure, e.g. at a pressure in the range of 1 bar to 10 bar. The cover gas may be an inert gas, or the processing gas containing the oxoacidity control component. The cover gas may for example contain water vapour as the oxoacidity control component at a partial pressure in the range of 0.01 bar to 2 bar, e.g. 0.02 bar to 0.5 bar. When the cover gas contains the oxoacidity control component, the cover gas may be bubbled through the molten salt of a metal hydroxide to be recirculated to the cover gas, and in particular, the content, e.g. expressed as partial pressure, of the oxoacidity control component may be replenished in the cover gas. For example, the oxoacidity control component may be added directly to the cover gas, which may then be bubbled through the molten salt of a metal hydroxide. By using the processing gas containing the oxoacidity control component as the cover gas and bubbling the cover gas through the molten salt of a metal hydroxide to recirculate the processing gas to the cover gas a setup is created where it is easy to control the oxoacidity of the molten salt of a metal hydroxide.

In an example, a gas is bubbled through the molten salt of a metal hydroxide. The gas may be an inert gas, i.e. an inert gas not containing the oxoacidity control component, a processing gas with the oxoacidity control component, or the oxoacidity control component in a gaseous form. When the gas contains the oxoacidity control component, the volume of gas bubbled through the molten salt of a metal hydroxide takes into account the intended amount of oxoacidity control component to be brought into contact with the molten salt of a metal hydroxide, and the amount of gas bubbled through the molten salt of a metal hydroxide may be expressed in the volume of inert gas relative to the volume of molten salt of a metal hydroxide per unit of time, so that the unit may be per hour (or h⁻¹). The volume of inert gas bubbled through the volume of molten salt of a metal hydroxide may be in the range of 0.1 h⁻¹ to 10 h⁻¹, e.g. 0.5 h⁻¹ to 2 h⁻¹. When a gas is bubbled through the molten salt of a metal hydroxide, the bubbles may create a forced circulation of the molten salt of a metal hydroxide, especially when the volume of gas bubbled through the volume of molten salt of a metal hydroxide is above 2 h⁻¹.

An oxoacidity control component may be present in a metal hydroxide before the salt is molten, and thereby the oxoacidity control component will also be present in the metal hydroxide salt once molten. However, due to the high temperature typically used for melting the salt and due to possible reactions between the oxoacidity control component and other components, the content of the oxoacidity control component will not be a constant over time. For example, the oxoacidity control component may evaporate from the molten salt.

The method comprises the step of estimating the target concentration of at least one of OH⁻, O²⁻, and H₂O in the molten salt of a metal hydroxide. The target concentration of the at least one of H₂O, O²⁻, and OH⁻ may be estimated at any temperature where the metal hydroxide is molten. In general, at least one temperature is sufficient to provide a useful estimate of the target concentration. However, it is preferred that the target concentration of the at least one of H₂O, O²⁻, and OH⁻ is estimated at least at three different temperatures in the range of the melting point and the boiling point of the salt of a metal hydroxide, or between the melting point of the salt of a metal hydroxide and 1000° C. The temperatures, e.g. the at least three temperatures, are preferably chosen to be within the intended temperature operating range of the setup. The at least three temperatures are different temperatures and the different temperatures should be separated from each other by at least 10° C., although the temperatures are preferably distributed over the temperature range where the metal hydroxide salt is molten, e.g. the temperatures may be selected at points removed from each other by at least 50° C., at least 100° C. or at least 200° C. For example, the temperatures may include a first temperature, e.g. a “low point temperature”, in the range of the melting point of the salt of a metal hydroxide to the melting point of the salt of a metal hydroxide +100° C., a second temperature, e.g. a “midpoint temperature”, in the range of ±50° C. from the midpoint between the melting point and the boiling point of the salt of a metal hydroxide, and a third temperature, e.g. a “high point temperature”, in the range of 100° C. below the boiling point of the salt of a metal hydroxide to the boiling point of the salt of a metal hydroxide. When the target concentration of the at least one of H₂O, O²⁻, and OH⁻ is estimated at least at three different temperatures in the range of the melting point and the boiling point of the salt of a metal hydroxide, in particular when the temperatures are separated from each other by at least 50° C. or at least 100° C., the present inventors have surprisingly found that the estimates of the target concentrations are useful over the full temperature range of the molten salt of the corresponding metal hydroxide. Thereby, the method provides a simple approach to utilise the full temperature range of a metal hydroxide salt.

In general, the target concentration represents the window of oxoacidity of a material, e.g. the lining material of a container containing the molten salt of a metal hydroxide, where the resistance to corrosion is optimal so that corrosion is minimised, and the target concentration may be a point or a range, typically expressed in terms of mol/L or mol/kg. Target concentrations generally depend on the lining material, e.g. the chemical composition of the lining material, and the operating temperature range. A theoretical analysis on Ni, Cr and Fe (the main components of typical high nickel alloys) highlights their common oxoacidity window of stability in NaOH at 800° C. For these, the H₂O concentration, expressed as p(H₂O)=−Log[H₂O], should be contained between 2.5 and 5.6, e.g. between 2.5 and 3.1. FIG. 2 depicts theoretical potential oxoacidity diagrams for Ni, Fe and Cr metals where the theoretical region of shared stability is highlighted as the shaded area. The thick contour shows the window of stability of the molten salt of sodium hydroxide at 800° C. However, the theoretical potential oxoacidity diagrams of FIG. 2 apply only for pure Ni, Fe and Cr metals. The present inventors have now found that for an alloy containing about 90% w/w Ni, the window of oxoacidity for H₂O is in the range of 0.1 to 40 mmol of H₂O per Kg of molten salt of a metal hydroxide, preferably between 1 to 15 mmol H₂O per Kg of molten salt of a metal hydroxide. Thus, the target concentration may be defined for a specific lining material. The target concentration may be expressed for one of OH⁻, O²⁻, and H₂O, or the target concentration may be expressed for a combination of two or all three of OH⁻, O²⁻, and H₂O. OH⁻, O²⁻, and H₂O contribute to the oxoacidity and by estimating the target concentration of one, two or all three of OH⁻, O²⁻, and H₂O, together with contacting the molten salt of a metal hydroxide with the processing gas comprising the oxoacidity control component, the oxoacidity of the molten salt of the metal hydroxide can be adjusted, in particular controlled, e.g. in accordance with Henry's law, to be within the window of oxoacidity of the lining material. In general, it is assumed that the amount of oxoacidity control component dissolved in the molten salt of a metal hydroxide when the oxoacidity control component is provided in a gaseous form is proportional to the partial pressure of the oxoacidity control component brought in contact with, e.g. by being above, the molten salt of a metal hydroxide (see FIG. 3). Thereby, the corrosion of the lining material is minimised. In a specific example, the molten salt of a metal hydroxide is located in a container having an inner surface made from a lining material, and the target concentration of the at least one of OH⁻, O²⁻, and H₂O is defined for the lining material. An empirical correlation between water vapour partial pressure in the processing gas and concentration of water in the molten salt of sodium hydroxide as found by the inventors is shown in FIG. 3.

Without application of an oxoacidity control component to a molten metal hydroxide salt, there may be only limited variations in the oxoacidity throughout the volume of the molten salt of a metal hydroxide, in particular when the molten salt of a metal hydroxide is stationary in a container, or when the molten salt of a metal hydroxide is circulated by natural convection. In general, when the molten salt of a metal hydroxide is stationary in a container, local variations in the oxoacidity of the molten salt of a metal hydroxide may exist, but the oxoacidity of the molten salt of a metal hydroxide beyond 20 cm, e.g. beyond 50 cm or beyond 100 cm, from the wall of the container is considered to have limited effect on the influence on the molten salt of a metal hydroxide on the wall of the container. However, the risk of corrosion is especially relevant at the interface between the molten metal hydroxide salt and any material, e.g. a lining material, in contact with the molten metal hydroxide salt. In a specific example, the molten salt of a metal hydroxide is located in a container having an inner surface made from a lining material, and the oxoacidity control component is brought into contact with the molten salt of a metal hydroxide located at a distance from the lining material in the range of 0 cm to 100 cm, e.g. 0 cm to 50 cm, or 0 cm to 20 cm. In particular, the molten salt of a metal hydroxide located within 100 cm, or within 50 cm or within 20 cm may be brought into contact with the oxoacidity control component over the distance from the wall of the container, e.g. the inner surface made from the lining material. Thus, the molten salt of a metal hydroxide may be stationary, e.g. in a container, and the molten salt of a metal hydroxide located at a distance from the lining material beyond 100 cm, e.g. beyond 50 cm or beyond 20 cm, may not be brought into contact with the oxoacidity control component, since the molten salt of a metal hydroxide beyond this distance from the inner walls of the container results in limited corrosion of the material of the inner wall of the container, e.g. the lining material. For example, the oxoacidity control component, e.g. an oxoacidity control component contained in an inert carrier gas or on a gaseous form, may be bubbled through the molten salt of a metal hydroxide at a distance, or over the distance, from the lining material, e.g. the wall of the container containing the molten salt of a metal hydroxide, in the range of 0 cm to 100 cm, e.g. 0 cm to 50 cm, or 0 cm to 20 cm from the lining material.

The container may have any size and shape as desired. For example, the container, especially a storage container, may have a central volume defined by a distance from the walls of the container. Thus, the container may have a central volume, where the distance to the walls of the container is at least 20 cm, at least 50 cm, or at least 100 cm. The molten salt of a metal hydroxide in the central volume is generally considered not to contribute to corrosion of the inner wall of a container. Exemplary container volumes are in the range of 1 m³ to 10 m³. In the context of the present method, a container may also be a pipe or conduit, e.g. a pipe or conduit for adding a salt of a metal hydroxide, e.g. in a molten form, to a storage container.

Industrial applications of a molten salt of a metal hydroxide, in particular when the molten salt of a metal hydroxide is used for energy storage, may involve being able to add heat to or remove heat from the molten salt of a metal hydroxide in order to take advantage of the large temperature range between the melting point and the boiling point of the molten salt of a metal hydroxide. Thus, in an example, the molten salt of a metal hydroxide is located in a container, and the container comprises a heat source and/or a heat sink configured to create a temperature gradient in the range of 0.1° C./cm to 100° C./cm, e.g. 0.1° C./cm to 10° C./cm, e.g. over a distance in the range of 5 cm to 50 cm, in the molten salt of a metal hydroxide. Other relevant temperature gradients are in the range of 0.1° C./cm to 5° C./cm, 0.15° C./cm to 2° C./cm, or 1° C. to 5° C./cm. The temperature gradient may be defined in terms of a temperature difference and a distance between the points where the temperatures are measured. In general, the temperature difference is recorded from a reference point, e.g. representing the molten salt of a metal hydroxide, and a further point representing the heat source and/or the heat sink, as appropriate. The temperature gradient may be expressed in relation to a distance, such as the distance from the heat sink to a point in the molten salt of a metal hydroxide or from the heat source to a point in the molten salt of a metal hydroxide, and the distance may be in the range of 1 cm to 100 cm, e.g. 10 cm to 50 cm. Thus, in an example, the temperature gradient, e.g. as recorded from the heat sink to a point in the molten salt of a metal hydroxide or from the heat source to a point in the molten salt of a metal hydroxide, is in the range of 1° C. over 10 cm to 10° C. over 10 cm, or 10° C. to 100° C. over 50 cm. In general, heat may be added to or removed from the molten salt of a metal hydroxide. In particular, heat may be added to or removed from the molten salt of a metal hydroxide to create forced convection in the molten salt of a metal hydroxide, and the when the molten salt of a metal hydroxide is thus in contact with a heat source or a heat sink, it is especially relevant to contact the molten salt of a metal hydroxide over a distance from the lining material, e.g. the wall of the container containing the molten salt of a metal hydroxide, in the range of 0 cm to 100 cm or 0 cm to 50 cm, or to employ forced circulation to provide a uniform oxoacidity of the molten salt of a metal hydroxide. Therefore, the present method is especially advantageous for large scale use of molten metal hydroxide salts for energy storage, since it allows protection of the inner wall of the container, e.g. the lining material. In a specific example, the method is for adjusting the oxoacidity of a molten metal hydroxide salt in an energy storage system having a container where the molten metal hydroxide salt is located, and the target concentration of at least one of H₂O, O²⁻, and OH⁻ is estimated from theoretical calculations, prior knowledge about a specific material, e.g. a pure metal, or as otherwise described herein, and the molten salt of a metal hydroxide is circulated in the container by forced convection obtained from a heat sink and/or a heat source configured to create a temperature gradient in the range of 0.1° C./cm to 10° C./cm over a distance in the range of 5 cm to 20 cm from the heat sink and/or the heat source, as appropriate, to a point in the molten salt of a metal hydroxide. For example, the temperature gradient may be at least 20° C. over a distance of 20 cm.

Adding and removing heat is likewise relevant when a molten salt of a metal hydroxide is used as a moderator in an MSR. For example, the fission reaction generates heat that is removed from the MSR in order to convert the generated heat into electricity. When the molten salt of a metal hydroxide is used in an MSR, heat is typically removed from the molten salt of a metal hydroxide with the aid of a heat exchanger, and the heat exchanger therefore creates forced convection in the molten salt of a metal hydroxide, and the oxoacidity control component may be added at any location in the MSR where the molten salt of a metal hydroxide is located. For example, the oxoacidity control component may be water vapour contained in an inert cover gas, so that the cover gas represents a processing gas, and the cover gas may optionally be bubbled through the molten salt of a metal hydroxide in a recycling loop, which may also comprise an addition point for water vapour.

The present method can be advantageous also in other uses of a molten salt of a metal hydroxide. Gas stream purification operated by contacting a contaminated gas with the molten salt of a metal hydroxide can be operated in a scrubber unit having a container with a lining material, and the lining material be protected by the methodology disclosed herein. The oxoacidity control component at the target concentration may be co-fed with the contaminated gas stream in the container of the scrubber unit through bubbling, determining simultaneously the purification of the gas stream and the oxoacidity adjustment of the molten salt of a metal hydroxide.

The molten salt of a metal hydroxide may be contacted with a processing gas containing the oxoacidity control component. In a specific example, the oxoacidity control component is added to the processing gas by sublimation of the oxoacidity control component from a solid state. For example, a metal oxide such as sodium or lithium oxide may be sublimated to generate a certain partial pressure of gas phase, molecular metal oxide, which is then mixed with the processing gas and used to control the oxoacidity of the molten salt of a metal hydroxide.

In yet a further example, the oxoacidity control component is added to the processing gas as a liquid via a spray or mist generation. For example, water may be sprayed into the processing gas, to reach a concentration of droplets in the processing gas that can provide the target concentrations of OH⁻, O²⁻, and/or H₂O in the molten salt of a metal hydroxide.

The target concentration of OH⁻, O²⁻, and H₂O in the molten salt of the metal hydroxide may be estimated using any procedure as desired. For pure metals, the target concentrations may be available from the scientific literature, see FIG. 2. However, the present inventors have now realised that as soon as a metal contains other components, e.g. alloying metals, non-alloying metals and/or non-metallic components, e.g. carbon, nitrogen, oxygen, boron and/or silicon, the presence of the other components, even at a purity of the metal of up to about 99%, influences the electrochemical properties compared to the same metal in a pure form without the other component(s), and thereby the metal with the components is differently, e.g. more, amenable to corrosion from molten hydroxides than the corresponding pure metal. The present inventors have devised a method to produce accurate data that correlate the steady-state concentration of the oxoacidity control component in the molten salt of a metal hydroxide with the corrosion attack of the hydroxide on the lining material. In particular, different metallic materials have different polarisation characteristics as dictated by the open circuit potential, breakdown potential, and passivation potential of the material. The detection of these electrochemical parameters allows identification of the corrosion factors of a material in the studied environment. The method is analogous to that used in aqueous corrosion studies, and it has been applied with modifications for studying corrosion in molten salts of a metal hydroxide. The set-up employed is especially advantageous as it allows for bench-scale analysis of the target concentration for a material of interest. Experimental results for an exemplary nickel alloy containing about 90% w/w nickel are shown in FIG. 4. In the present context, a three-electrode arrangement may be used where the three electrodes are in contact with a molten salt of a metal hydroxide. The arrangement includes a lining material of interest as a working electrode, a reference electrode, and a counter electrode made of pure nickel or another appropriate metal, such as a nickel-based superalloy suspected to have good resistance to molten hydroxide corrosion. In an example, a beta-alumina sodium reference is used as the reference electrode. Potentials reported in this disclosure are referred to this reference electrode. An exemplary setup includes a high temperature electrochemical cell comprising a vessel, e.g. a metallic vessel, where a crucible of an inert material, e.g. a crucible made from graphite, is placed, which contains the molten salt of the metal hydroxide. The vessel has a lid to maintain the control of the atmosphere, e.g. the atmosphere above the molten salt of the metal hydroxide, of the experiment. The lid further has openings allowing penetration of electrodes, and a gas inlet and a gas outlet for adding and removing a gas, e.g. the processing gas to be analysed. All openings can be closed and/or opened as appropriate for the experimental setup. The gas inlet may also be used for the addition of non-gaseous components to the molten salt of the metal hydroxide. An exemplary electrochemical cell is illustrated in FIG. 1. The arrangement allows measuring the potential versus the current as a potentiodynamic polarisation, and the arrangement may include any sensors and computers and the like for controlling and measuring the electrical parameters. For example, the arrangement may include a multi-channel potentiostat/galvanostat controlled by a computer, such as a PARSTAT

(Princeton Applied Research, Hampshire, the UK). This potentiostat/galvanostat can be set up to automatically target a desired potential between the working and reference electrodes by passing an appropriate current between the working and the counter electrode. The polarisation of the working electrode may be accomplished potentiodynamically so that the potential is changed continuously. This changing may occur at sweep rates of 20 mV/s or 50 mV/s. Before polarisation diagrams are established experimentally, the corrosion potential of the working electrode can be determined against the reference electrode under open-circuit conditions, i.e., the applied current is zero. An approximate constant value of the open-circuit potential may be achieved after a couple of minutes to hours. Then, the working electrode may be anodically polarised starting at a potential 100 mV more negative than the open-circuit potential up to a transpassivity potential. Due to the stochastic nature of corrosion phenomena, polarisation tests can be repeated at least three times for each material to be studied and under the test conditions to be employed. Moreover, scales/corrosion products formed during the polarisation tests on the samples may be metallographically examined, using post-analysis, e.g. by means of scanning electron microscopy (SEM) combined with energy-dispersive X-ray spectroscopy (EDS) to evaluate if the materials undergo any microstructural changes upon polarisation. In an exemplary setup, test conditions to be investigated may be different target concentrations of the oxoacidity control component in the processing gas. In an example, argon may be used as the carrier gas, either dry or wet, and wet argon gas, as the exemplary processing gas, may be generated by contacting the argon with water in a thermostatic water bath, e.g. at a temperature in the range of 30° C. to 90° C.

In another aspect, the invention relates to a method of determining a window of oxoacidity for a material, the method comprising the steps of:
selecting a material of interest and a metal hydroxide,
providing a crucible of an inert material,
applying the metal hydroxide in the crucible of an inert material and heating the metal hydroxide to provide a molten salt of the metal hydroxide,
providing a working electrode made from the material of interest, a reference electrode, and a counter electrode made of an inert metal,
inserting the working electrode, the reference electrode, and the counter electrode in the molten salt of the metal hydroxide,
applying a gas above the molten salt of the metal hydroxide and adding an oxoacidity control component to the gas,
applying a current between the working electrode and the counter electrode and recording the polarisation of the working electrode,
determining the window of oxoacidity of the material of interest from the polarisation of the working electrode.

In one embodiment, there is provided a method of determining a window of oxoacidity for a material, the method comprising the steps of
selecting a material of interest and a metal hydroxide,
providing a crucible of an inert material,
applying the metal hydroxide in the crucible of an inert material and heating the metal hydroxide to provide a molten salt of the metal hydroxide,
inserting a coupon made of the material of interest in the molten salt of the metal hydroxide,
adding an oxoacidity control component to a processing gas and contacting the processing gas with the molten salt of the metal hydroxide,
determining the oxoacidity window of the material from the loss of weight of the coupon.

The two methods of determining a window of oxoacidity for a material are appropriate for estimating the target concentration of at least one of H₂O, O²⁻, and OH⁻ in a molten salt of a metal hydroxide in the first aspect, i.e. the method of adjusting the oxoacidity of a molten salt, and the material of interest may be a lining material of a container for containing a molten salt of the metal hydroxide. The metal hydroxide may be any metal hydroxide, e.g. a hydroxide of an alkali metal or an earth alkaline metal, and the oxoacidity control component may be as defined above. The inert material may be any material suspected to have good resistance to molten hydroxide corrosion, such as graphite.

The methods are appropriate for estimating the oxoacidity window. In the first embodiment, the window of oxoacidity of the material of interest is determined from the polarisation of the working electrode. In the second embodiment, this is done by measuring the corrosion rate of a material by measuring the loss of weight of the coupon in a range of oxoacidities. The metal hydroxide may be any metal hydroxide, e.g., a hydroxide of an alkali metal or an earth alkaline metal.

Thus, by measuring the difference in weight of the coupon of the selected material before and after it has been exposed to the molten salt of a metal hydroxide contacted with a processing gas comprising the oxoacidity control component, e.g. at a controlled partial pressure, the rate of corrosion will be obtained. For example, the rate of corrosion may be expressed in units of length per time, e.g. mm/year (mm/y), relative to the thickness of the coupon. The window of oxoacidity for the material is then determined as the oxoacidity, e.g. the range of oxoacidities, providing the lowest rate of corrosion. In the present context, a corrosion rate of 0.1 mm/y is generally considered to be acceptable for a material to be used for an MSR, in an energy or heat storage container, or in scrubber units operating with molten hydroxides.

The counter electrode may be made from any metal suspected of having good resistance to molten hydroxide corrosion, such as nickel, e.g. pure nickel or a metal, such as a nickel-based superalloy suspected to have good resistance to molten hydroxide corrosion. The reference electrode may be based on alumina, e.g. a beta-alumina sodium reference electrode.

Thus, by estimating the oxoacidity of the molten salt of a metal hydroxide and contacting the molten salt of a metal hydroxide with the processing gas comprising the oxoacidity control component at a controlled partial pressure, the oxoacidity can be maintained in the window of oxoacidity, i.e. to provide oxoneutral conditions, for the lining material to thereby minimise corrosion of the lining material from the molten salt of a metal hydroxide. For example, the oxoacidity control component may be water vapour, and the water vapour may be added to the processing gas to provide a partial pressure of water in the processing gas. The molten salt of a metal hydroxide will be at a temperature much higher than the boiling point of water, even at increased pressure, and water added to the processing gas will be in vapour form regardless of the conditions of the molten salt of a metal hydroxide. The concentration of water vapour in the processing gas may be expressed as a volumetric percentage, and the concentration of water vapour in the processing gas may be selected freely. For example, the concentration of water vapour in the processing gas may be in the range of 5% V/V to 95% V/V. Correspondingly, the concentration of inert carrier in the processing gas may be in the range of 95% V/V to 5% V/V. However, in general the water vapour will be described in terms of its partial pressure in the processing gas. The partial pressure of water vapour may for example be in the range of 0.01 bar to 2 bar, e.g. 0.02 bar to 0.5 bar. The partial pressure of water vapour, and also the amount of processing gas, appropriate for a specific example of the method is determined by the estimate(s) of the target concentrations of the at least one of OH⁻, O²⁻, and H₂O in a molten salt of a metal hydroxide.

In a specific example, the oxoacidity control component is water vapour and the water vapour is added to the processing gas to provide a partial pressure of water in the processing gas. For example, the water vapour may be added to the processing gas by contacting the processing gas with water. Any method to contact the water with the processing gas may be used, and in an example, the processing gas is bubbled through a water bath, e.g. a thermostatic water bath. The processing gas bubbled through the water bath may be the inert carrier gas without any water content, or the processing gas may already contain an amount, e.g. a trace amount, of water vapour, especially an amount of water below the target concentration. After bubbling the processing gas through the water bath, the processing gas, now containing the water vapour, is brought into contact with the molten salt of a metal hydroxide. The partial pressure of the water vapour in the processing gas may be controlled by at least one of: controlling the temperature of the water bath, controlling the residence time of the processing gas in the water bath; and controlling the pressure of the processing gas in the water bath. In general, the water bath will be at a temperature below the boiling point of water for the water in the water bath to be liquid. An optimal temperature range to obtain an appropriate partial pressure of water in the processing gas is in the range of 25° C. to 90° C., e.g. 30° C. to 50° C.

Any embodiment of the invention may be used in any aspect of the invention, and any advantage for a specific embodiment applies equally when an embodiment is used in a specific aspect.

### BRIEF DESCRIPTION OF THE DRAWINGS

In the following the invention will be explained in greater detail with the aid of examples and with reference to the schematic drawings, in which

FIG. 1 shows an electrochemical cell for estimating a target concentration of at least one of OH⁻, O²⁻, and H₂O in a molten salt of a metal hydroxide according to the disclosure;

FIG. 2 shows a potential oxoacidity diagram for Ni, Fe and Cr;

FIG. 3 shows an empirical correlation between the water partial pressure in the processing gas, and the steady state concentration of H₂O in a molten salt of sodium hydroxide;

FIG. 4 shows potentiodynamic data measured for Ni alloy in molten NaOH at 600° C.;

FIG. 5 shows the rate of corrosion for Ni alloy in molten NaOH.

The invention is not limited to the embodiment/s illustrated in the drawings. Accordingly, it should be understood that where features mentioned in the appended claims are followed by reference signs, such signs are included solely for the purpose of enhancing the intelligibility of the claims and are in no way limiting on the scope of the claims.

The term “comprising” as used in this specification and claims means “consisting at least in part of”. When interpreting statements in this specification and claims which include the term “comprising”, other features besides the features prefaced by this term in each statement can also be present. Related terms such as “comprise” and “comprised” are to be interpreted in a similar manner.

### DETAILED DESCRIPTION

The present invention relates to a method of adjusting the oxoacidity of a molten metal hydroxide salt. The method will now be illustrated in the following non-limiting examples.

### Example 1

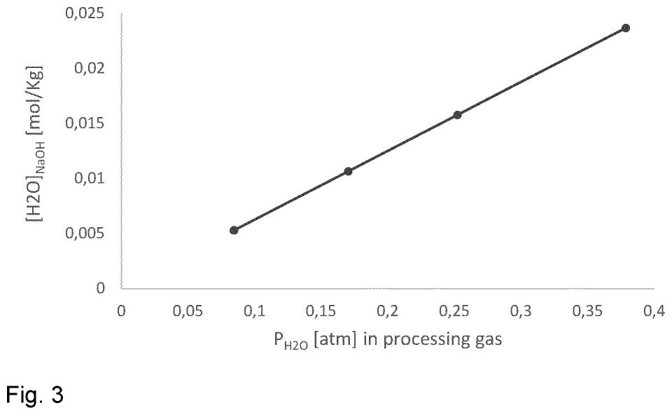

An experiment was set up to determine the correlation between the water partial pressure in the processing gas, and the steady state concentration of H₂O in a molten salt of sodium hydroxide. Specifically, NaOH was added to a graphite crucible in a vessel made from pure nickel. The vessel had a lid with an opening for adding gas and an opening for removing gas so that the composition of the gas above the crucible could be controlled, and the vessel further had openings for a thermometer and a gas analyser probe. The vessel was placed in a container of mineral wool and heated by applying a current to a heating wire in the mineral wool, and the crucible was heated to 600° C. to melt the sodium hydroxide. Once the sodium hydroxide was molten, the amount of water vapour in the gas above the crucible was increased gradually, and the content of water in the molten sodium hydroxide was measured after increasing the water content in the gas. The results are shown in FIG. 3, which shows that a linear correlation between the water vapour in the gas and the water content in the molten sodium hydroxide was observed.

### Example 2

Two high Ni-content commercial alloys containing more than 70% w/w nickel were analysed to determine the target concentrations. One alloy contains about 90% w/w nickel and iron, manganese, silicon, copper, and carbon. Even though iron, manganese, silicon, copper, and carbon are present in what may be considered trace amounts, the amounts are sufficient to demand that the alloy is analysed to determine the target concentrations. The other alloy contains more than 70% w/w nickel, >10% w/w chromium, >5% w/w iron and other components. The target concentrations of H₂O, O²⁻, and OH⁻ for these alloys cannot be predicted from the target concentrations of the individual components in a pure form.

Samples of the two alloys were analysed in a graphite reference crucible with sodium hydroxide as an exemplary metal hydroxide salt. The analyses were conducted at temperatures in the range of the melting point of sodium hydroxide and 900° C. Water vapour was used as the oxoacidity control component, and the amount of water in the molten salt of sodium hydroxide was obtained from the correlation depicted in FIG. 3,

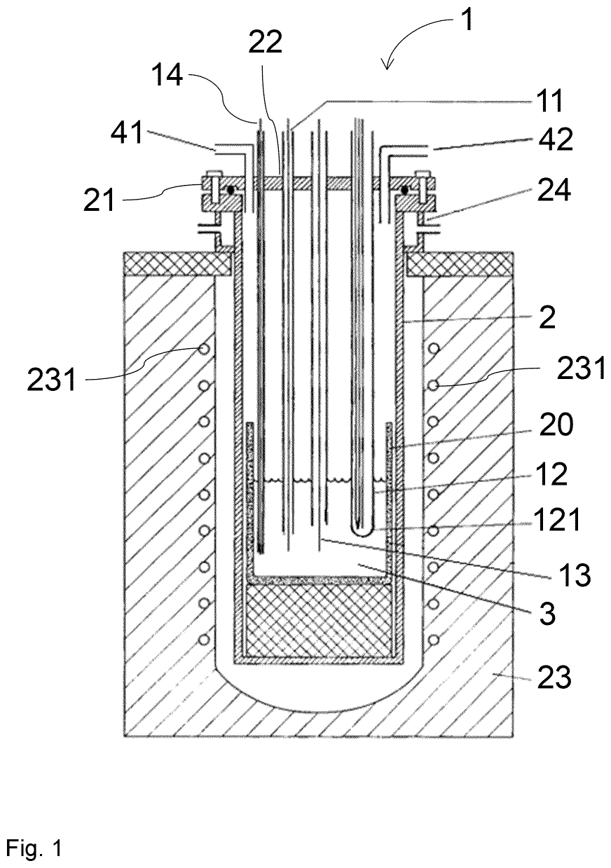

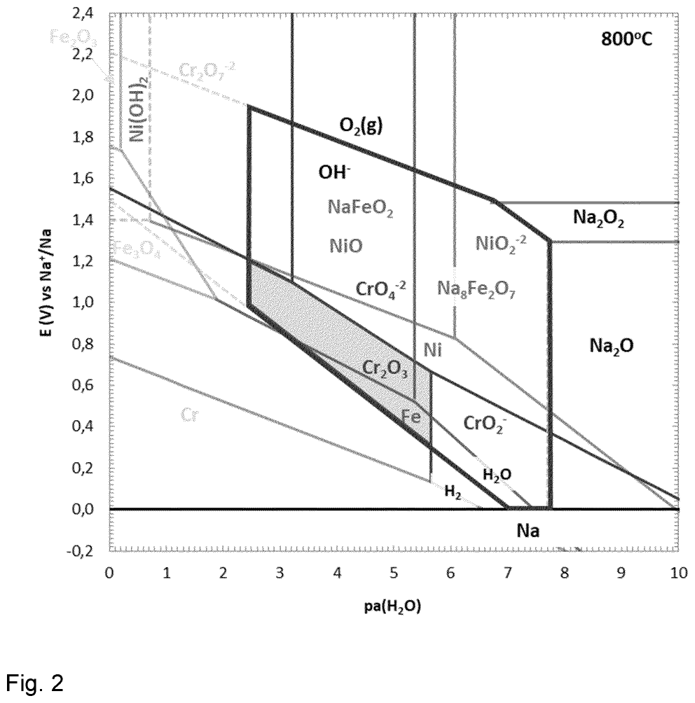

Specifically, the two alloys were analysed in an electrochemical cell 1 as illustrated in FIG. 1. The alloy containing more than 90% w/w nickel was supplied by Q-metal as a wire with a diameter of 1 mm, and the alloy containing more than 70% w/w nickel was supplied as a wire with a diameter of 1 mm by Merck. The electrochemical cell 1 had a vessel 2 made from pure nickel, which contained a crucible 20 made from graphite. Pellets of NaOH were added to the crucible 20, and the vessel 2 with the crucible 20 was placed in a container of mineral wool as an insulating material 23 and heated by applying a current to a heating wire 231 made from copper to melt the NaOH and provide the molten salt of the metal hydroxide 3. The NaOH was received from Honeywell with a nominal purity of ≥98% at 600° C.

The vessel 2 had a lid 21 mounted on a cell support 24, and the lid 21 had openings 22 for a working electrode 11, a reference electrode 12, a counter electrode 13, and a thermocouple 14 as well as for a gas inlet 41 and a gas outlet 42. It is to be understood that openings 22 may be used for any item or device that is appropriately contacted with the molten salt of a metal hydroxide 3. The gas inlet 41 and the gas outlet 42 contained stainless steel pipes and pumps to add/remove the processing gas to be analysed.

The working electrode 11 was made from one of the alloys to be analysed, and the reference electrode 12 and the counter electrode 13 were made from pure nickel. The reference electrode 12 was contained in a membrane 121 of beta-alumina 121. The electrodes 11, 12, 13 were connected to a PARSTAT multi-channel potentiostat/galvanostat (not shown) that was controlled by a computer (not shown). The potentiostat/galvanostat was set up to maintain a potential between the working and reference electrodes by passing a direct current between the working electrode 11 and the counter electrode 13, and the potential was continuously changed to analyse the polarisation of the working electrode 11. Specifically, the changing occurred at sweep rates of 20 mV/s or 50 mV/s.

Before the polarisation diagrams were established by experiments the corrosion potential of the working electrode 11 was determined against the reference electrode 12 under open-circuit conditions, i.e., the applied current was zero. An approximate constant value of the open-circuit potential was usually achieved after couple of minutes. Then, the working electrode 11 was anodically polarised starting at a potential 100 mV more negative than the open-circuit potential up to transpassivity potential. Due to the stochastic nature of corrosion phenomenon, polarisation tests were repeated three times for each of the working electrode 11 materials.

Moreover, formation of scales/corrosion products during the polarisation tests on the test alloys was examined metallographically, using post-analysis by means of scanning electron microscopy combined with energy-dispersive X-ray spectroscopy (SEM/EDS) to evaluate if the materials undergo any microstructural changes after polarisation.

Argon was used as the carrier gas, and wet argon was generated, as an exemplary processing gas, by bubbling argon through a water bath (not shown) at the temperatures of 36° C., 50° C. or 90° C. The wet argon was introduced into the vessel 2 via the gas inlet 41. In order to maintain the pressure at ambient pressure, excess gas was removed from the vessel 2 via the gas outlet 42.

The results of this practical example show the methodology to find the optimal oxoacidity window for a given material, but the results are not exhaustive. Multiple test conditions can be assessed, for an accurate evaluation of the oxoacidity window. Furthermore, the example employed one temperature of the molten salt, but multiple temperatures can appropriately be evaluated to define the suitable oxoacidity window in a practical commercial setup to take temperature transients into account.

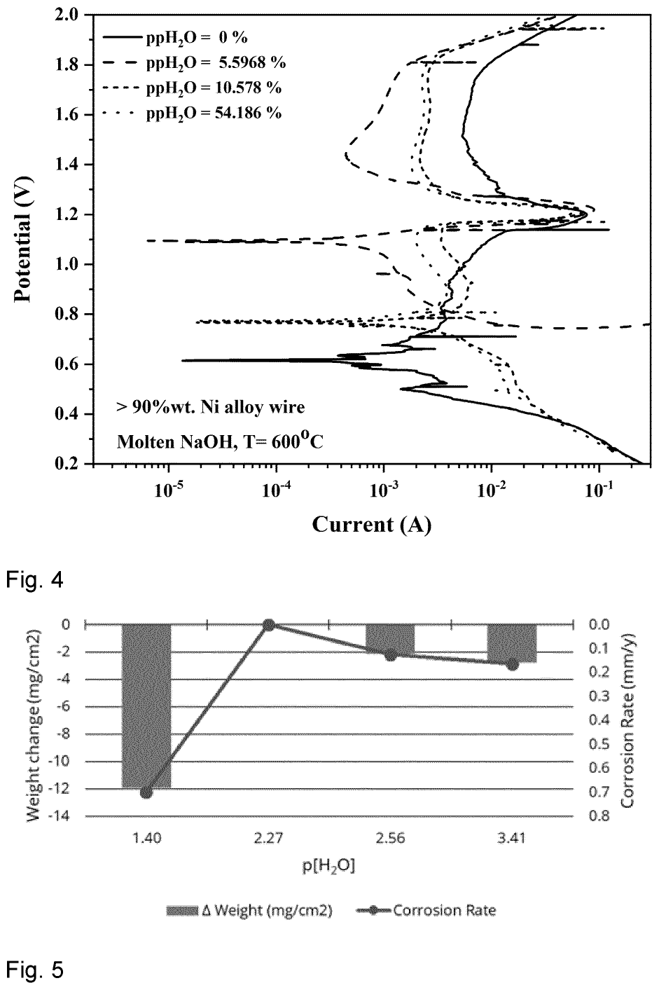

The results for the nickel alloy containing about 90% w/w nickel are shown in FIG. 4, which shows the variation of current vs. potential as determined. Different electrochemical responses were obtained on the same type of sample at different partial pressures of water (ppH₂O) in the processing gas used to adjust the steady state concentration of water in the molten salt. By comparing the different profile, the inventors defined the target oxoacidity conditions to be used in the oxoacidity control of a full-scale setup. FIG. 4 shows a clear corrosion mitigation for ppH₂O=5.5968% in a cover gas of total pressure 1 atm. Two major features in the plot indicate improvements by adjusting the water partial pressure. First, the peaks in the potential region between 0.4 and 1.2 V are assigned to the corrosion potential region. The higher the potential, the higher the resistance to corrosion of the materials at the operating conditions. The black line, corresponding to no addition of water in the molten salt, performed the worst, with a corrosion potential peak at 0.6V. The salt was highly oxobasic and corroded the sample easily. Notably, an excessive amount of ppH₂O in the processing gas was also poorly mitigating the corrosion of the sample, albeit to a lower extent. The blue and green lines correspond to oxoacidic conditions of the salt, determining a corrosion potential around 0.77 V. Finally, the red line shows the corrosion mitigation achievable with careful control of the target oxoacidity. Under these conditions, the inventors believe the molten salt is in oxoneutral conditions, i.e. in between oxobasic and oxacidic relative to the chosen lining material. In this oxoacidity window, the corrosion potential peak can be greatly increased, reaching a value of 1.1 V.

Furthermore, another region of the plot shows the corrosion mitigation achieved by the right water target concentration. In the potential region 1.2 V to 2 V, the formation of a protective passive layer can be observed. The lower the current, the stronger the protective passivation. With the right target concentration for the lining material, the surface chemistry on the material is stabilised, allowing formation of a stable metal oxide on the surface that protects the uncorroded material layers beneath the surface, in analogy with the Cr oxide passivation layer obtained in conventional stainless steel exposed to air/moisture. It can be observed in this region of the plot, that again the first ppH₂O (red line) performs best in protecting from corrosion, meanwhile the oxobasic regime (black line) is the worst at promoting the formation of a stable oxide layer on the material, and the second (green) and third (blue) ppH₂O concentration determine oxoacidic conditions and a similar partial protection effect.

### Example 3

An experiment was set up to analyse the 90% nickel alloy also used in Example 2. A sample of the alloy was analysed in an alumina crucible with sodium hydroxide as an exemplary metal hydroxide salt. The analyses were conducted at temperatures in the range of the melting point of sodium hydroxide and 900° C. Water vapour was used as the oxoacidity control component, and the amount of water in the molten salt of sodium hydroxide was obtained from the correlation depicted in FIG. 3.

Specifically, pellets of NaOH were added to the alumina crucible, and the crucible was placed in a container of mineral wool as an insulating material and heated by applying a current to a copper heating wire wound around the crucible to melt the NaOH and provide the molten salt of the metal hydroxide. The NaOH was received from Honeywell with a nominal purity of ≥98% at 600° C.

The alloy was supplied by Q-metal as a coupon having a thickness of 3 mm, a length of 20 mm and a width of 7 mm. Coupons were cleansed and dried before weighing and then inserted into the molten NaOH. The coupons were removed from the molten NaOH after a week, and residues of molten NaOH were removed from the surfaces of the coupons before cooling the coupons to ambient temperature and weighing them. The weight loss for each coupon was recorded and expressed relative to the surface area (i.e. the length times the width) of the coupon in the unit mg/cm². From the duration of exposure to the molten NaOH, the corrosion rate was calculated and expressed relative to the thickness of the coupons in the unit mm/year (mm/y). The results are shown in FIG. 5, which shows the weight change and corrosion rate at different oxoacidity levels determined with a ±0.1 mm/y corrosion rate. Different corrosion rates were obtained on the same type of sample at different partial pressures of water (ppH₂O) in the processing gas used to adjust the steady state concentration of water in the molten salt. FIG. 5 shows the result obtained from the weight change and inductively coupled plasma optical emission spectrometry (ICP-OES) result. The lowest corrosion rate from the weight change calculation is found to be 0 mm/y with a p[H₂O] of 2.27.

### REFERENCE SIGNS LIST

1 Electrochemical cell
2 Vessel
20 Crucible
21 Lid
22 Opening
23 Insulating material
231 Heating wire
24 Cell support
3 Molten salt of a metal hydroxide
11 Working electrode
12 Reference electrode
121 Membrane
13 Counter electrode
14 Thermocouple
41 Gas inlet
42 Gas outlet

1. A method of adjusting the oxoacidity of a molten metal hydroxide salt in an energy or heat storage container where the hydroxide salt provides a medium for energy or heat storage, the method comprising the steps of:
estimating a target concentration of at least one of H₂O, O²⁻, and OH in a molten salt of a metal hydroxide;
providing an oxoacidity control component; and
contacting the oxoacidity control component with the molten salt of a metal hydroxide to adjust the oxoacidity of the molten salt of a metal hydroxide.

2. The method of adjusting the oxoacidity of a molten salt according to claim 1, wherein the oxoacidity control component is provided in a processing gas comprising an inert carrier gas, and the method further comprises contacting the processing gas comprising the oxoacidity control component with the molten salt of a metal hydroxide to adjust the oxoacidity of the molten salt of a metal hydroxide.

3. The method of adjusting the oxoacidity of a molten salt according to claim 2, wherein the oxoacidity control component is water vapour, and the water vapour is added to the processing gas to provide a partial pressure of water in the processing gas.

4. The method of adjusting the oxoacidity of a molten salt according to claim 3, wherein the water vapour is added to the processing gas by bubbling the processing gas through a water bath, and the partial pressure of the water vapour in the processing gas is controlled by at least one of:
controlling the temperature of the water bath,
controlling the residence time of the processing gas in the water bath; and
controlling the pressure of the processing gas in the water bath.

5. The method of adjusting the oxoacidity of a molten salt according to claim 2, wherein the oxoacidity control component is added to the processing gas by sublimation of the oxoacidity control component from a solid state.

6. The method of adjusting the oxoacidity of a molten salt according to claim 2, wherein the oxoacidity control component is added to the processing gas as a liquid via a spray or mist generation.

7. The method of adjusting the oxoacidity of a molten salt according to claim 2, wherein the oxoacidity control component is selected from H₂O, H₂ and HF.

8. The method of adjusting the oxoacidity of a molten salt according to claim 1, wherein the molten salt of a metal hydroxide is located in a container having an inner surface made from a lining material, and the target concentration of the at least one of OH⁻, O²⁻, and H₂O is defined for the lining material.

9. The method of adjusting the oxoacidity of a molten salt according to claim 8, wherein the molten salt of a metal hydroxide is stationary or is circulated in the container by forced convection or forced circulation.

10. The method of adjusting the oxoacidity of a molten salt according to claim 8, wherein the oxoacidity control component is brought into contact with the molten salt of a metal hydroxide located at a distance from the lining material in the range of 0 cm to 100 cm.

11. The method of adjusting the oxoacidity of a molten salt according to claim 1, wherein heat is added or removed from the molten salt of a metal hydroxide.

12. The method of adjusting the oxoacidity of a molten salt according to claim 8, wherein the container comprises a heat source and/or a heat sink configured to create a temperature gradient in the range of 0.1° C./cm to 10° C./cm in the molten salt of a metal hydroxide.

13. The method of adjusting the oxoacidity of a molten salt according to claim 1, wherein a cover gas above the molten salt of a metal hydroxide is maintained at a pressure above ambient pressure.

14. The method of adjusting the oxoacidity of a molten salt according to claim 2, wherein a cover gas above the molten salt of a metal hydroxide is maintained at a pressure above ambient pressure, and wherein the cover gas is the processing gas.

15. The method of adjusting the oxoacidity of a molten salt according to claim 2, wherein the processing gas is bubbled through the molten salt of a metal hydroxide.

16. The method of adjusting the oxoacidity of a molten salt according to claim 1, wherein the target concentration of the at least one of H₂O, O²⁻, and OH⁻ is estimated at at least three different temperatures in the range of the melting point and the boiling point of the salt of a metal hydroxide.

17. A method of determining a window of oxoacidity for a material, the method comprising the steps of:
selecting a material of interest and a metal hydroxide,
providing a crucible of an inert material,
applying the metal hydroxide in the crucible of an inert material and heating the metal hydroxide to provide a molten salt of the metal hydroxide,
providing a working electrode made from the material of interest, a reference electrode, and a counter electrode made of an inert metal,
inserting the working electrode, the reference electrode, and the counter electrode in the molten salt of the metal hydroxide,
applying a gas above the molten salt of the metal hydroxide and adding an oxoacidity control component to the gas,
applying a current between the working electrode and the counter electrode and recording the polarisation of the working electrode,
determining the window of oxoacidity of the material of interest from the polarisation of the working electrode.

18. The method of adjusting the oxoacidity of a molten salt according to claim 17, wherein the oxoacidity control component is selected from H₂O, H₂ and HF.

19. A method of determining a window of oxoacidity for a material, the method comprising the steps of selecting a material of interest and a metal hydroxide,
providing a crucible of an inert material,
applying the metal hydroxide in the crucible of an inert material and heating the metal hydroxide to provide a molten salt of the metal hydroxide,
inserting a coupon made of the material of interest in the molten salt of the metal hydroxide,
adding an oxoacidity control component to a processing gas and contacting the processing gas with the molten salt of the metal hydroxide,
determining the oxoacidity window of the material from the loss of weight of the coupon.

20. The method of adjusting the oxoacidity of a molten salt according to claim 19, wherein the oxoacidity control component is selected from H₂O, H₂ and HF.

21. An energy storage system comprising a container, a heat sink and/or a heat source, and a molten metal hydroxide salt located in the container, wherein the molten salt of a metal hydroxide is circulated in the container by forced convection obtained from the heat sink and/or the heat source, which heat sink and/or which heat source is configured to create a temperature gradient in the range of 0.1° C./cm to 10° C./cm over a distance from the heat sink and/or the heat source, as appropriate, to a point in the molten salt of a metal hydroxide.

22. The energy storage system according to claim 20, wherein the heat sink and/or the heat source is configured to contact the molten salt of a metal hydroxide over a distance from the lining material in the range of 0 cm to 100 cm.

23. The energy storage system according to claim 21, wherein the distance from the heat sink and/or the heat source, as appropriate, to the point in the molten salt of a metal hydroxide is in the range of 5 cm to 20 cm.

24. The energy storage system according to claim 21, wherein the oxoacidity of the molten metal hydroxide salt is adjusted in the steps of:
estimating a target concentration of at least one of H₂O, O²⁻, and OH⁻ in a molten salt of a metal hydroxide;
providing an oxoacidity control component; and
contacting the oxoacidity control component with the molten salt of a metal hydroxide to adjust the oxoacidity of the molten salt of a metal hydroxide.
